(19) United States
(12) Patent Application Publication
(10) Pub. No.: US 2019/0159636 A1
(43) Pub. Date: May 30, 2019

(54) Foam Machine

(71) Applicant: Dongguan Lomak Optoelectronics Technology Co. Ltd., Dongguan (CN)

(72) Inventor: James Chi-Wai Lo, Tsuen Wan (HK)

(21) Appl. No.: 16/206,315

(22) Filed: Nov. 30, 2018

(30) Foreign Application Priority Data
Nov. 30, 2017 (CN) 201721649740.3

(51) Int. Cl. A47K 5/12; B05B 1/06; B05B 7/00; B05B 11/00

(52) U.S. Cl. CPC A47K 5/1217; A47K 5/1205; B05B 1/06; A47K 5/14; B05B 11/3001; B05B 11/3045; B05B 7/0031

(57) ABSTRACT

The present disclosure is a foam machine which is convenient to use, triggers foam generation and extrusion by a sensor, and effectively avoids cross infection caused by hands making contact with the machine.

### TECHNICAL FIELD

The present disclosure relates to the technical field of foam machines, and in particular to a foam machine.

### BACKGROUND ART

There are a variety of foam machines available on the market, such as manually activated soap lotion dispensing machines, which aerate a foaming material (e.g., a soap lotion) after being pressed by hand to form foam for hand washing.

Using a foamed lotion soap can reduce the amount of soap lotion required by up to 40%, and means that the foamed lotion soap is more environmentally friendly than common un-foamed lotion soap. However, for the existing manual lotion soap machines and other similar sanitary devices, foam cannot be generated without a hand making contact with the machines or devices, so in public places, the existing manually activated soap lotion foam dispensing machines may cause cross-infection.

It is an object of the present disclosure to provide a soap dispenser which addresses or ameliorates at least some of the above problems or deficiencies.

### SUMMARY

In view of the problems identified with the prior art devices, the present disclosure provides a foam machine which is convenient to use, triggers foam generation and extrusion by a sensor, and effectively avoids cross infection caused by hands making contact with the machine.

In an aspect of the present disclosure there is provided a foam dispensing apparatus comprises a liquid storage bottle, an air-liquid mixing pump, a sensor, a foam nozzle, a control circuit board and a power supply device, wherein the power supply device, the air-liquid mixing pump and the sensor are respectively and electrically connected with the control circuit board, the foam nozzle is connected in communication with the air-liquid mixing pump, and the sensor is arranged on one side of the foam nozzle; and the liquid storage bottle is connected in communication with the air-liquid mixing pump through a pipe, and the pipe is provided with a check valve.

In a further aspect, the air-liquid mixing pump comprises an electric motor, an eccentric wheel, a movable connecting rod, a three-cavity soft rubber part, a valve part and an air-liquid mixing chamber, the movable connecting rod being fixedly connected with the eccentric wheel, a rotating shaft of the electric motor being connected with the eccentric wheel, and the movable connecting rod being connected with the three-cavity soft rubber part; the three-cavity soft rubber part is provided with at least two air cavities and a liquid cavity, and the valve part is provided with air valves and a liquid valve for respectively cooperating with the air cavities and the liquid cavity; and a middle part of the valve part is provided with an intermediate valve for cooperating with the air-liquid mixing chamber.

Optionally, the three-cavity part may be provided with a first clamp post, a second clamp post and a third clamp post for cooperating with the movable connecting rod, and the movable connecting rod is provided with a first clamp hole, a second clamp hole and a third clamp hole for engaging with the first clamp post, the second clamp post and the third clamp post.

Further, the eccentric wheel may be provided with a first shaft hole for connecting with the rotating shaft of the electric motor; and a middle part of the movable connecting rod is provided with a fixed shaft, and the eccentric shaft is provided with a second shaft hole for connecting with the fixed shaft.

Further, the air-liquid mixing pump may be internally provided with an accommodating part, and the accommodating part is internally provided with an air inlet cavity and a liquid inlet cavity respectively corresponding to the air valve and the liquid valve.

The accommodating part may be provided with an air inlet hole corresponding to the air inlet cavity, and the accommodating part is provided with a liquid inlet channel corresponding to the liquid inlet cavity.

The liquid storage bottle may comprises a bottle body and a cover body, the bottle body being provided with an opening, a snap ring being sleeved at the opening, and the cover body being provided with a clamp block for clamping the snap ring; and the clamp block is provided with a through-hole for the pipe to pass through, one end of the pipe extending into the bottle body through the through-hole, and the other end of the pipe being connected in communication with the liquid inlet channel.

Further a foam generator may be installed between the foam nozzle and the air-liquid mixing pump, the foam generator comprising a foam outlet device and a foam inlet device, a foam outlet piece being provided between the foam inlet device and the foam outlet device, the foam outlet piece being provided with foam outlet holes uniformly arranged at intervals, the foam nozzle being provided with a sleeving post, and the sleeving post being sleeved inside the foam outlet device.

Optionally, the sleeving post is provided with a bump, and the foam outlet device is provided with a groove for accommodating the bump, the bump being engaged with the groove.

Advantageously, the sensor is an infrared sensor.

In a further aspect of the disclosure there is provided a foam generating dispenser, comprising:

a sensing device electrically connected to a foam generator, the foam generator comprising an electric motor having a rotating shaft connected to an eccentric wheel, a three-cavity part having at least two air cavities and a liquid cavity,
a movable connecting rod connected to the three-cavity part and fixedly connected to the eccentric wheel;
an air-liquid mixing chamber;
a valve part having air valves and a liquid valve for respectively cooperating with the air cavities and the liquid cavity of the three-cavity part; and a middle part provided with an intermediate valve for cooperating with the air-liquid mixing chamber.
Optionally, the three-cavity part may be provided with a first clamp post, a second clamp post and a third clamp post for cooperating with the movable connecting rod, and the movable connecting rod is provided with a first clamp hole, a second clamp hole and a third clamp hole for engaging with the first clamp post, the second clamp post and the third clamp post.
The eccentric wheel may be provided with a first shaft hole for connecting with the rotating shaft; and a middle part of the movable connecting rod provided with a fixed shaft, the eccentric wheel is provided with a second shaft hole for connecting with the fixed shaft, and the second shaft hole fixed to the movable connecting rod at a deviation angle.
Optionally the sensing device comprises a sensing head and an electronic controller, the sensing head being electrically connected to the electronic controller, and the electronic controller being connected to the electric motor.
Advantageously, the foam generator may be internally provided with an accommodating part, and said accommodating part is internally provided with an air inlet cavity and a liquid inlet cavity respectively at locations corresponding to the air valve and the liquid valve.
Optionally the accommodating part may be provided with an air inlet hole corresponding to the air inlet cavity, and the accommodating part is provided with a liquid inlet channel corresponding to the liquid inlet cavity.
A foaming material bottle and a liquid inlet pipe, with one end of the liquid inlet pipe connected to the foaming material bottle, and the other end of the liquid inlet pipe being connected to the liquid inlet channel may also be included. The foaming material bottle may have a delivery pipe and a foam outlet device, with one end of the delivery pipe being connected to the air-liquid mixing chamber, and the other end of the delivery pipe being connected to the foam outlet device.
The foam outlet device may be provided with a metal mesh sheet and a nozzle for overflow of foam. Advantageously, the foam outlet device may be internally provided with a number of through holes for uniform extrusion therethrough.
In yet a further aspect there is provided a foam generating dispenser comprising an electric motor connected to an eccentric wheel via a rotating shaft, the electric motor being actuable by a sensor;
a three-cavity part defining therein two cavities for receiving air therein and one cavity for receiving liquid therein,
a movable connecting rod fixedly connected to the eccentric wheel and to the three-cavity part for rotation thereof;
an air-liquid mixing chamber;
a valve part having two air valves operably coupled to the air cavities of the three-cavity part and a liquid valve coupled to the liquid cavity of the three-cavity part; and a middle part provided with an intermediate valve for passage therethrough of the air and liquid to the air-liquid mixing chamber.
Advantageously, a nozzle may be attached to outlet of the air liquid mixing chamber, the nozzle comprising a plurality of holes therethrough.

### BRIEF DESCRIPTION OF THE DRAWINGS

FIG. 1 is a schematic structural diagram of an embodiment of a foam dispensing apparatus.

FIG. 2 is an exploded structural diagram of the air-liquid mixing pump of an embodiment of the foam dispensing apparatus=.

FIG. 3 is an exploded structural diagram in another view of the air-liquid mixing pump of the embodiment of the foam dispensing apparatus depicted in FIG. 1.

FIG. 4 is a sectional view of the air-liquid mixing pump depicted in FIG. 3.

FIG. 5 is an exploded structural diagram of the foam generator and the foam nozzle of the foam dispensing apparatus of FIG. 1.

FIG. 6 is an exploded structural diagram of the liquid storage bottle of the foam dispensing apparatus of FIG. 1.

FIG. 7 is an exploded structural diagram in another view of the liquid storage bottle of the foam dispensing apparatus of FIG. 1.

FIG. 8 is a schematic structural diagram of the embodiment of the foam generating device.

FIG. 9 is a schematic structural diagram of the embodiment of the foam generating device of FIG. 8.

FIG. 10 is an exploded structural diagram of the embodiment of the foam generating device of FIG. 8.

FIG. 11 is an exploded structural diagram of the embodiment of the foam generating device of FIG. 8.

FIG. 12 is an exploded structural diagram in another view of the embodiment of the foam generating device of FIG. 8.

FIG. 13 is a sectional view of the foam generating device of FIG. 8.

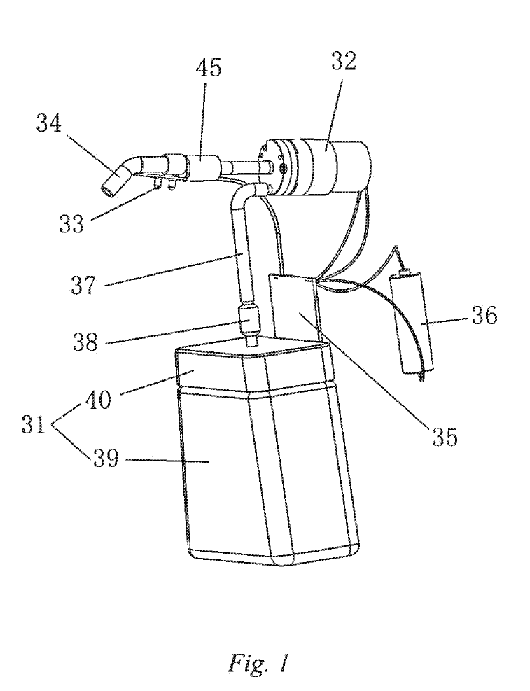

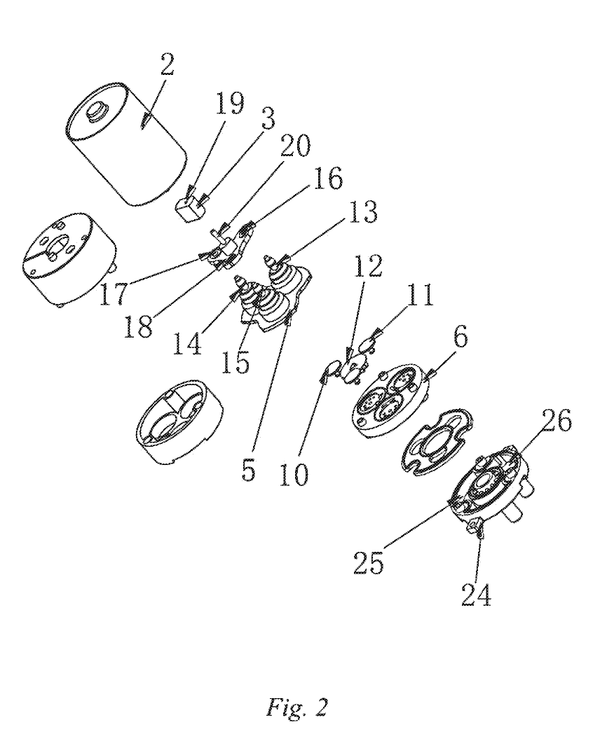

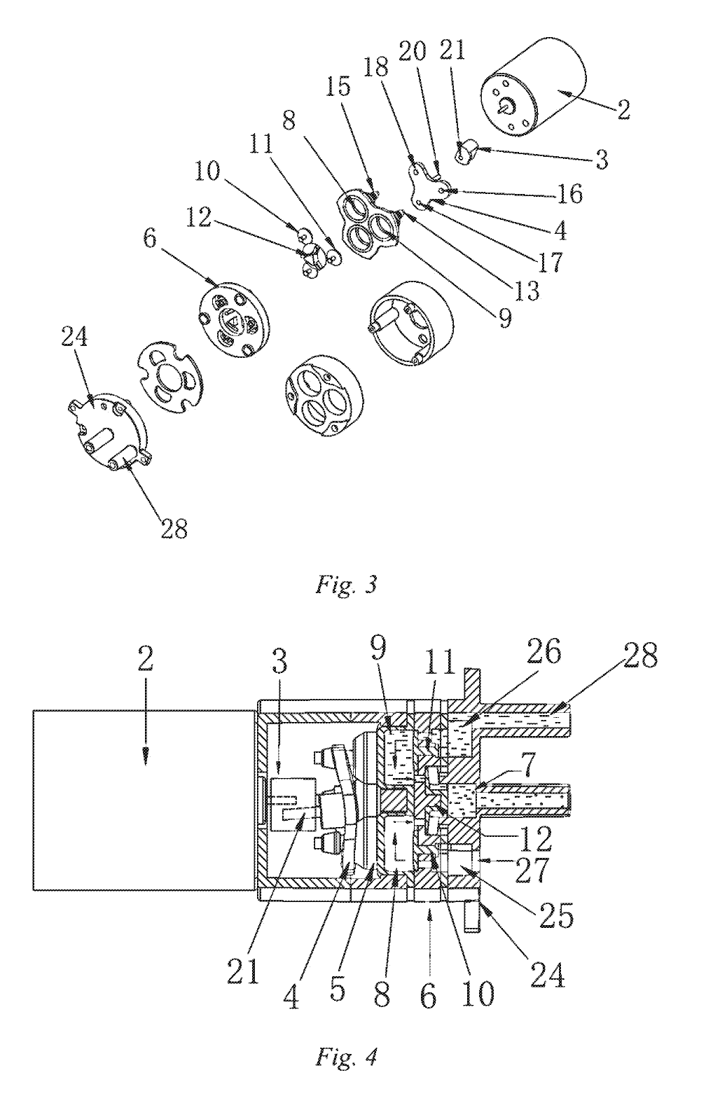

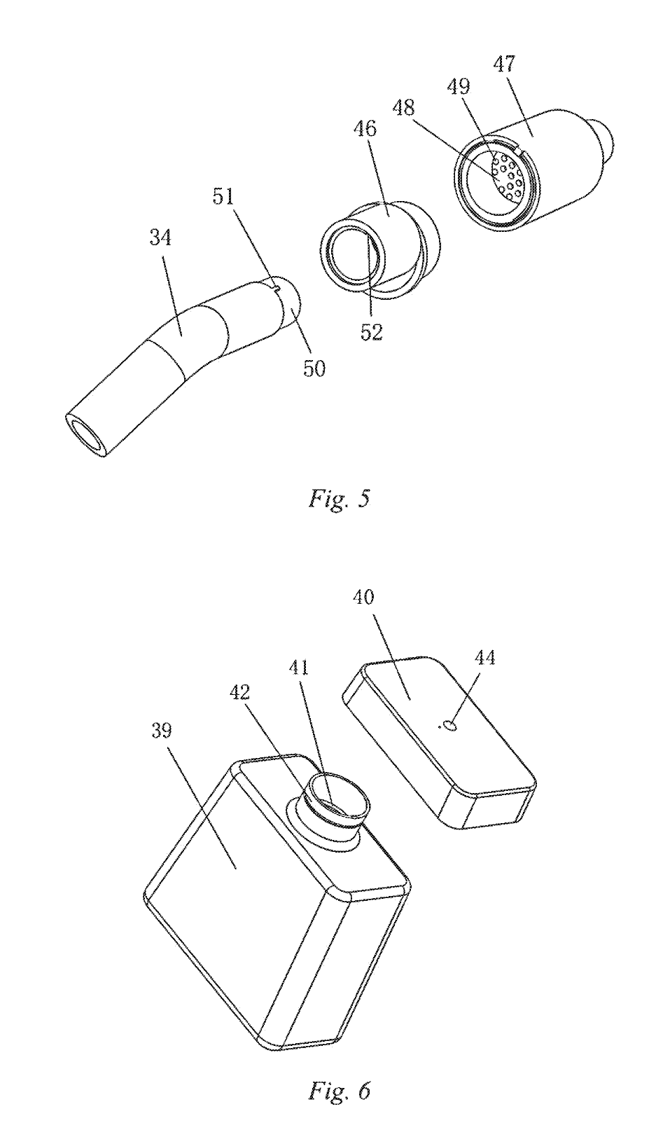

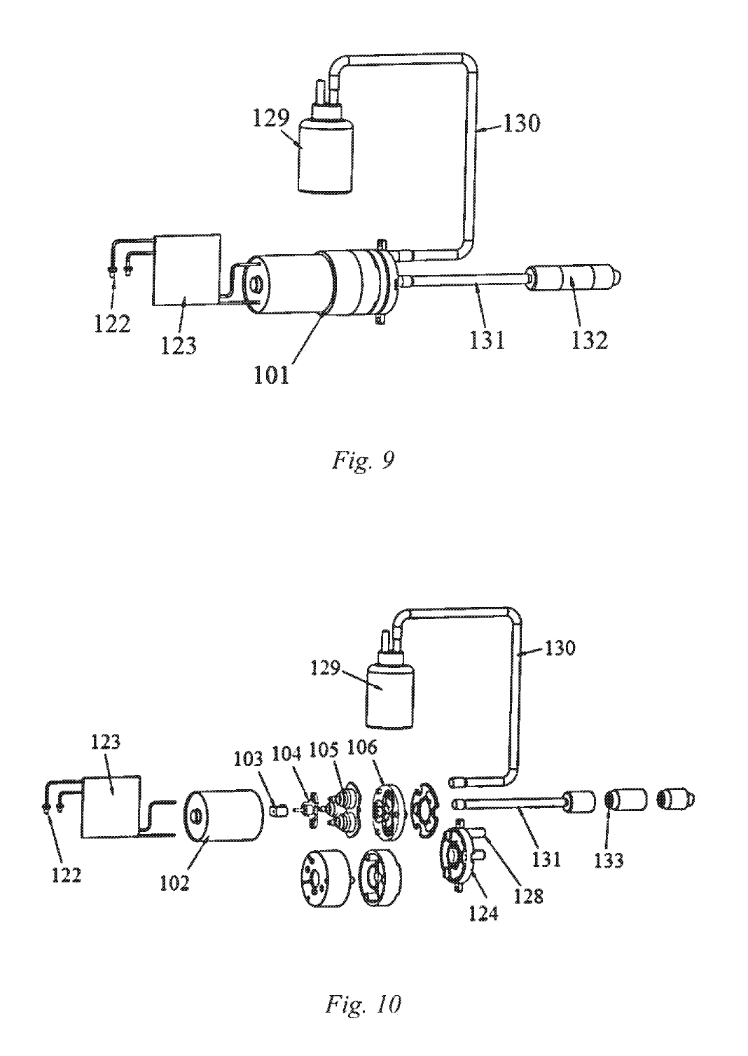

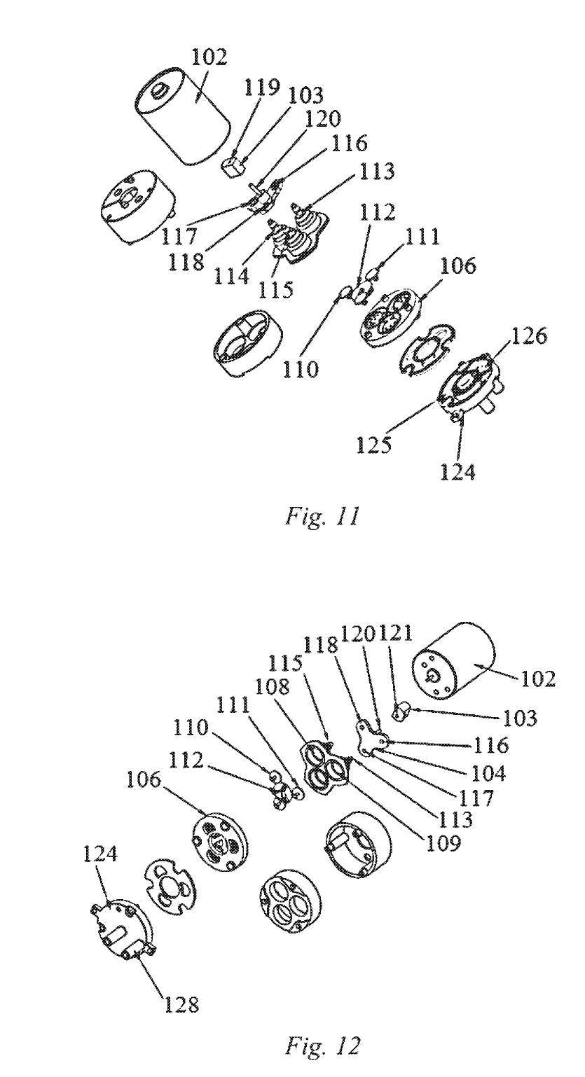

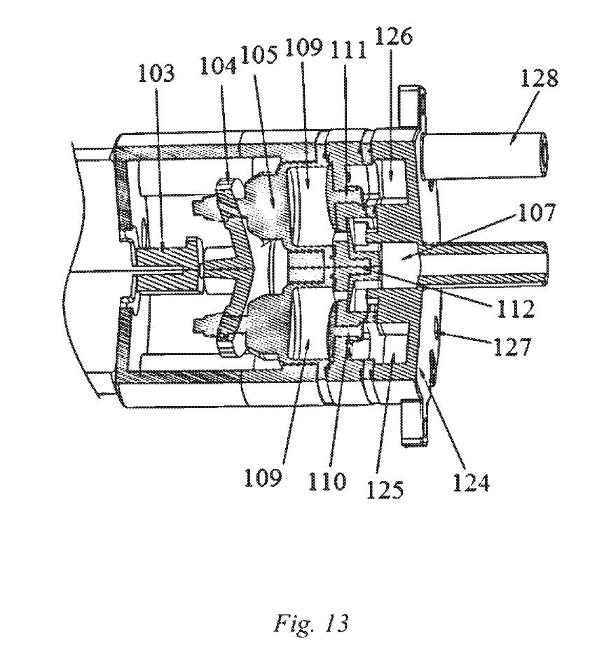

The reference numerals in FIGS. 1 to 13 include:

| | | |
|---|---|---|
| 2 - Electric motor | 3 - Eccentric wheel | |
| 4 - Movable connecting rod | 5 - Three-cavity soft rubber part | 6 - Valve part |
| 7 - air-liquid mixing chamber | 8 - Air cavity | 9 - Liquid cavity |
| 10 - Air valve | 11 - Liquid valve | 12 - Intermediate valve |
| 13 - First clamp post | 14 - Second clamp post | 15 - Third clamp post |
| 16 - First clamp hole | 17 - Second clamp hole | 18 - Third clamp hole |
| 19 - First shaft hole | 20 - Fixed shaft | 21 - Second shaft hole |
| 24 - Accommodating part | 25 - Air inlet cavity | 26 - Liquid inlet cavity |
| 27 - Air inlet hole | 28 - Liquid inlet channel | |
| 31 - Liquid storage bottle | 32 - air-liquid mixing pump | 33 - Sensor |
| 34 - Foam nozzle | 35 - Control circuit board | 36 - Power supply device |
| 37 - Pipe | 38 - Check valve | 39 - Bottle body |
| 40 - Cover body | 41 - Opening | 42 - Snap ring |
| 43 - Clamp block | 44 - Through-hole | 45 - Foam generator |
| 46 - Foam outlet device | 47 - Foam inlet device | 48 - Foam outlet piece |
| 49 - Foam outlet hole | 50 - Sleeving post | 51 - Bump |
| 52 - Groove. | | |
| 101-Eccentrically driven foam generator | 102-Electric motor | 103-Eccentric wheel |
| 104-Movable connecting rod | 105-Three-cavity part | 106-Valve part |
| 107-Air-liquid mixing chamber | 108-Air cavity | 109-Liquid cavity |
| 110-Air valve | 111-Liquid cavity | 112-Intermediate valve |
| 113-First clamp post | 114-Second clamp post | 115-Third clamp post |
| 116-First clamp hole | 117-Second clamp hole | 118-Third clamp hole |
| 119-First shaft hole | 120-Fixed shaft | 121-Second shaft hole |
| 122-Sensing head | 123-Electronic controller | 124-Accommodating part |
| 125-Air inlet cavity | 126-Liquid inlet cavity | 127-Air inlet hole |
| 128-Liquid inlet channel | 129-Foaming material bottle | 130-Liquid inlet pipe |
| 131-Delivery pipe | 132-Foam outlet device | 133-Metal mesh sheet |
| 134-Nozzle | 135-Through hole | |

### DETAILED DESCRIPTION OF THE EMBODIMENTS

In order to facilitate the understanding of those skilled in the art, the present disclosure will be further described in conjunction with the embodiments and the accompanying drawings, and the content mentioned in the embodiments is not intended to limit the present disclosure. As shown in FIGS. 1 to 7, and in the further embodiment depicted in FIGS. 8-12, a foam dispensing apparatus comprises a liquid storage bottle 31, an air-liquid mixing pump 32, a sensor 33, a foam nozzle 34, a control circuit board 35 and a power supply device 36, wherein the power device 36, the air-liquid mixing pump 32 and the sensor 33 are respectively and electrically connected with the control circuit board 35, the foam nozzle 34 is connected in communication with the air-liquid mixing pump 32, and the sensor 33 is arranged on one side of the foam nozzle 34; the liquid storage bottle 31 is connected in communication with the air-liquid mixing pump 32 through a pipe 37, and the pipe 37 is provided with a check valve 38.

Specifically, when the sensor 33 is triggered, for example, the sensor 33 is triggered when a human hand approaches the sensor 33, the air-liquid mixing pump 32 is actuated by the control circuit board 35, air (taken from the environment external of the pump) and a liquid for foaming in the liquid storage bottle 31 are introduced by the air-liquid mixing pump 32 into and mixed in the air-liquid mixing pump 32, and the air and the liquid for foaming are mixed to form foam and are then squeezed out from the foam nozzle 34. The one-way valve 38 prevents the liquid for foaming from flowing backwards in the pipe as well as opens a channel for facilitating movement of the liquid therethrough. Advantageously, the foam dispensing apparatus of the present disclosure is convenient to use, triggers foam generation and extrusion by a sensor, and effectively avoids cross infection caused by hands making contact with the machine.

According to a foam machine of this embodiment, the air-liquid mixing pump 32 comprises an electric motor 2, an eccentric wheel 3, a movable connecting rod 4, a three-cavity soft rubber part 5, a valve part 6 and an air-liquid mixing chamber 7, the movable connecting rod 4 being fixedly connected with the eccentric wheel 3, a rotating shaft of the electric motor 2 being connected with the eccentric wheel 3, and the movable connecting rod 4 being connected with the three-cavity soft rubber part 5.

It would be appreciated by persons skilled in the art that the soft rubber part 5 referred to herein could also be advantageously produced from other suitable materials such as plastic, vinyl etc without departing from the scope of the present disclosure.

As depicted, the three-cavity soft rubber part 5 is provided with at least two air cavities 8 and a smaller size liquid chamber 9, and the valve part 6 is provided with air valves 10 and a liquid valve 11 for respectively cooperating with the air cavities 8 and the liquid cavity 9; and the middle part of the mixing valve part 6 is provided with an intermediate valve 12 for cooperation with the air-liquid mixing chamber 7.

Specifically, when the sensor 33 is triggered, the electric motor 2 is actuated by the control circuit board 35 to rotate so as to drive the eccentric wheel 3 to rotate, and since the eccentric wheel 3 is fixedly connected with the movable connecting rod 4, the movable connecting rod 4 is connected with the three-cavity soft rubber part 5 and further drives the movable connecting rod 4 to move in an eccentric motion to further drive the three-cavity soft rubber part 5 to move.

When the three-cavity soft rubber part 5 is moving, the air valve 10 or the liquid valve 11 of the valve part 6 is driven to open to further introduce air or the liquid for foaming in the liquid storage bottle 31 into the air cavity 8 or the liquid cavity 9 (respectively), so that the air and the liquid for foaming flow into the air-liquid mixing chamber 7 through the intermediate valve 12, and the air and the liquid for foaming are mixed to form foam in the air-liquid mixing chamber 7.

According to a foam dispensing apparatus of this embodiment, the three-cavity soft rubber part 5 is provided with a first clamp post 13, a second clamp post 14 and a third clamp post 15 for cooperating with the movable connecting rod 4, The movable connecting rod 4 is provided with a first clamp hole 16, a second clamp hole 17 and a third clamp hole 18 for respectively engaging with the first clamp post 13, the second clamp post 14 and the third clamp post 15.

Specifically, by respectively engaging the first clamp hole 16, the second clamp hole 17 and the third clamp hole 18 with the first clamp post 13, the second clamp post 14 and the third clamp post 15 to further connect the three-cavity soft rubber part 5 with the movable connecting rod, three-cavity soft rubber part 5 moves under control of the movable connecting rod 4.

According to a foam dispensing apparatus of this embodiment, the eccentric wheel 3 is provided with a first shaft hole 19 for connecting with the rotating shaft of the electric motor 2; the middle part of the movable connecting rod 4 is provided with a fixed shaft 20, and the eccentric shaft 3 is provided with a second shaft hole 21 for connecting with the fixed shaft 20.

Specifically, the eccentric wheel 3 is connected with the rotating shaft of the electric motor 2 through the first shaft hole 19 and connected with the fixed shaft 20 of the movable connecting rod 4 through the second shaft hole 21. A deviation angle is required when the second shaft hole is connected with the fixed shaft 20 of the movable connecting rod 4, so that when the eccentric wheel 3 rotates, due to the deviation angle when the eccentric shaft 3 is connected with the fixed shaft 20, the eccentric wheel 3 in rotation drives the movable connecting rod 4 to move in eccentric motion and further drives the three-cavity soft rubber part 5 to move.

According to a foam dispensing machine of this embodiment, the air-liquid mixing pump 32 is internally provided with an accommodating part 24, and the accommodating part 24 is internally provided with air inlet cavity 25 and a liquid inlet cavity 26 respectively corresponding to the air valve 10 and the liquid valve 11. Specifically, when the three-cavity soft rubber part 5 moves, the air valve 10 or the liquid valve 11 of the valve part 6 is driven to open so as to further introduce air or the liquid for foaming into the air inlet cavity 25 or the liquid inlet cavity 26 first and then into the air cavity 8 or the liquid cavity 9.

According to a foam machine of this embodiment, the accommodating part 24 provided with an air inlet hole 27 corresponding to the air inlet cavity 25, and the accommodating part 24 is provided with a liquid inlet channel 28 corresponding to the liquid inlet cavity 26. Specifically, air enters the air intake chamber 25 through the air intake hole 27, and the liquid for foaming enters the liquid inlet cavity 26 through the liquid inlet channel 28.

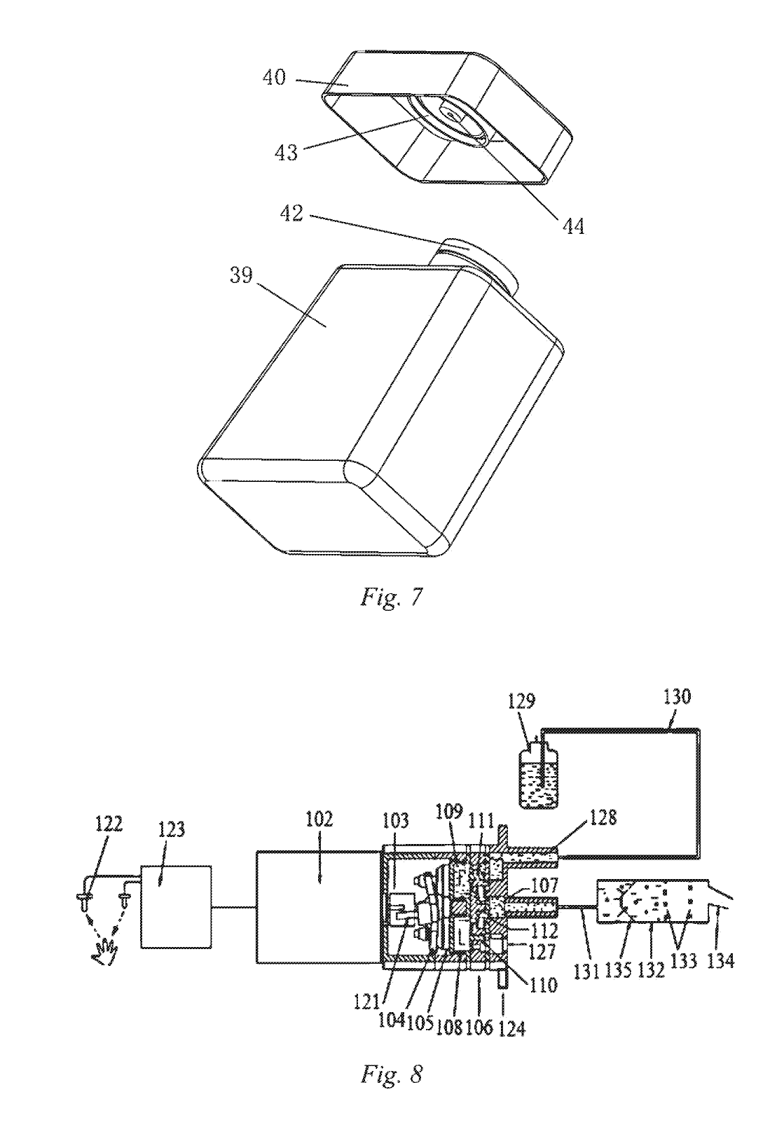

According to a foam dispensing machine of this embodiment, the liquid storage bottle 31 comprises a bottle body 39 and a cover body 40. The bottle body 39 is provided with an opening 41, a snap ring 42 being sleeved at the opening 41, and the cover body 40 being provided with a clamp block 43 for clamping the snap ring 42; the clamp block 43 is provided with a through-hole 44 for the pipe 37 to pass through, one end of the pipe 37 extending into the bottle body 39 through the through-hole 44, and the other end of the pipe 37 being connected in communication with the liquid inlet channel 28. (The pipe 37 has been omitted from FIGS. 6 and 7 for clarity).

Specifically, by engaging the clamp block 43 with the snap ring 42, the detachable installation of the cover body 40 and the bottle body 39 is provided, and when liquid for foaming needs to be introduced into the bottle body 39, an operator can open and pull the cover body 40, so that the clamp block 43 is detached from the snap ring 42, then the liquid for foaming is added through the opening 41. By engaging the clamp block 43 with the snap ring 42, the opening 41 is covered by the cover body 40, and the pipe 37 can pass through and extend into the bottle through the through-hole 44, so that the liquid for foaming in the liquid storage bottle 31 can be used by the air-liquid mixing pump 32.

According to a foam dispensing machine of this embodiment, a foam generator 45 is installed between the foam nozzle 34 and the air-liquid mixing pump 32, the foam generator 45 comprising a foam outlet device 46 and a foam inlet device 47, a foam outlet piece 48 being provided between the foam inlet device 47 and the foam outlet device 46, the foam outlet piece 48 being provided with foam outlet holes 49 uniformly arranged at intervals, the foam nozzle 34 being provided with a sleeving post 50, and the sleeving post 50 being sleeved inside the foam outlet device 46. Specifically, foam from the air-liquid mixing pump 32 enters the foam inlet device 47 of the foam generator 45 and then passes through the foam outlet piece 48 and enters the foam outlet device 46, and the foam is squeezed out from the foam nozzle 34, and the foam passes through the foam outlet hole 49 and mesh of the foam outlet piece 48 so that the foam can be squeezed out from the foam nozzle 34 more uniformly.

According to a foam dispensing machine of this embodiment, the sleeving post with mesh 50 is provided with a protrusion 51, and the foam outlet device 46 is provided with a groove 52 for accommodating the protrusion 51, the protrusion 51 being engaged with the groove 52. Specifically, by engaging the protrusion 51 with the groove 52, the foam nozzle 34 can be accurately sleeved inside the foam outlet device 46 to ensure high installation accuracy.

According to a foam dispensing machine of this embodiment, the sensor 33 is an infrared sensor.

Referring to the embodiment depicted in FIGS. 8-12 there is depicted as foam generating device comprises a sensing device and an eccentrically driven foam generator 101 which is electrically connected to a sensor, the eccentrically driven foam generator 101 comprising an electric motor 102, an eccentric wheel 103, a movable connecting rod 104, a three-cavity part 105, a valve part 106 and an air-liquid mixing chamber 107, wherein the movable connecting rod 104 is fixedly connected to the eccentric wheel 103, a rotating shaft of the electric motor 102 is to connected to the eccentric wheel 103, and the movable connecting rod 104 is connected to the three-cavity soft rubber part 105, the three-cavity soft rubber part 5 is provided with at least two air cavities 108 and a liquid chamber 109, and the valve part 106 is provided with air valves 110 and a liquid valve 111 for respectively cooperating with the air cavities 108 and the liquid cavity 109; and the middle part of the valve part 106 is provided with an intermediate valve 112 for cooperation with the air-liquid mixing chamber 107. Specifically, when the sensing device is triggered, for example, when a human hand approaches the sensing device, the sensing device is triggered to power on, the electric motor 102 is actuated to rotate so as to drive the eccentric wheel 103 to rotate, and since the eccentric wheel 103 is fixedly connected with the movable connecting rod 104, the movable connecting rod 104 is connected with the three-cavity soft rubber part 105 and further drives the movable connecting rod 104 to move in an eccentric motion to further drive the three-cavity part 105 to move, and when the three-cavity part 105 is moving, the air valve 110 or the liquid valve 111 of the valve part 106 is driven to open to further introduce air or the liquid for foaming into the air cavity 108 or the liquid cavity 109, so that the air and the liquid for foaming flow into the air-liquid mixing chamber 107 through the intermediate valve 112, and the air and the liquid for foaming are mixed to form foam in the air-liquid mixing chamber 107.

According to this embodiment, the three-cavity part 115 is provided with a first clamp post 113, a second clamp post 114 and a third clamp post 115 for cooperating with the movable connecting rod 104, and the movable connecting rod 104 is provided with a first clamp hole 116, a second clamp hole 117 and a third clamp hole 118 for respectively engaging with the first clamp post 113, the second clamp post 114 and the third clamp post 115. Specifically, by respectively engaging the first clamp hole 116, the second clamp hole 117 and the third clamp hole 118 with the first clamp post 13, the second clamp post 114 and the third clamp post 115 to further connect the three-cavity soft rubber part 105 with the movable connecting rod, three-cavity soft rubber part 105 moves with the movable connecting rod 104 when the movable connecting rod 4 is moving.

According to this embodiment, the eccentric wheel 103 is provided with a first shaft hole 119 for connecting with the rotating shaft; the middle part of the movable connecting rod 104 is provided with a fixed shaft 120, and the eccentric shaft 103 is provided with a second shaft hole 121 for connecting with the fixed shaft 120. Specifically, the eccentric wheel 103 is connected with the rotating shaft of the electric motor 102 through the first shaft hole 119 and connected with the fixed shaft 120 of the movable connecting rod 104 through the second shaft hole 121; A deviation angle is required when the second shaft hole is connected with the fixed shaft 120 of the movable connecting rod 104, so that when the eccentric wheel 103 rotates, due to the deviation angle when the eccentric shaft 103 is connected with the fixed shaft 120, the eccentric wheel 103 in rotation drives the movable connecting rod 104 to move in eccentric motion and further drives the three-cavity part 105 to move.

According to this embodiment, the sensing device comprises a sensing head 122 and an electronic controller 123, the sensing head 122 being electrically connected to the electronic controller 123, and the electronic controller 123 being electrically connected to the electric motor 102. Specifically, the sensing head 122 may be an infrared or other inductive sensing head 122, and when a human hand approaches the sensing head 122, the electronic controller 123 is triggered to power on, and then the electric motor 102 is triggered by the electronic controller 123 so as to drive the eccentric wheel 103 to rotate.

According to this embodiment, the eccentrically driven foam generator 101 is internally provided with an accommodating part 124, and the accommodating part 124 is internally provided with air inlet cavity 125 and a liquid inlet cavity 126 respectively corresponding to the air valve 110 and the liquid valve 111. Specifically, when the three-cavity part 105 moves, the air valve 110 or the liquid valve 111 of the valve part 106 is driven to open so as to further introduce air or the liquid for foaming into the air inlet cavity 125 or the liquid inlet cavity 126 first and then into the air cavity 108 or the liquid cavity 109.

According to this embodiment, the accommodating part 124 is provided with an air inlet hole 127 corresponding to the air inlet cavity 125, and the accommodating part 124 is provided with a liquid inlet channel 128 corresponding to the liquid inlet cavity 126. Specifically, air enters the air intake chamber 125 through the air intake hole 127, and the liquid for foaming enters the liquid inlet cavity 126 through the liquid inlet channel 128.

Advantageously, this embodiment further comprises a foaming material bottle 129 and a liquid inlet pipe 130, with one end of the liquid inlet pipe 130 being connected to the foaming material bottle 129, and the other end of the liquid inlet pipe 130 being connected to the liquid inlet channel 128. Specifically, when the three-cavity part 105 is moving, the liquid cavity 111 is opened, and liquid in the foaming material bottle 129 flows into the liquid inlet cavity 126 through the liquid inlet pipe 130. A delivery pipe 131 and a foam outlet device 132 may be included, with one end of the delivery pipe 131 being connected to the air-liquid mixing chamber 107, and the other end of the delivery pipe 131 being connected to the foam outlet device 132. Specifically, foam in the air-liquid mixing chamber 107 is delivered to the foam outlet device 132 through the delivery pipe 131.

The foam outlet device 132 is internally provided with a metal mesh sheet 133 and a nozzle 134 for overflow of foam. Specifically, the metal mesh sheet 133 is uniformly provided with fine mesh holes, and foam passes through the metal mesh sheet 133 so that the foam overflows more uniformly from the nozzles 134.

The foam outlet device is internally provided with a number of through holes 135. Specifically, the flow of the foaming material liquid is accelerated by the action of the through holes 135.

The foam dispensing apparatus of the present disclosure has the following beneficial effects: when the sensor is triggered, for example, the sensor is triggered when a human hand approaches the sensor, the air-liquid mixing pump is actuated by the control circuit board, air and a liquid for foaming in the liquid storage bottle are introduced by the air-liquid mixing pump into and mixed in the air-liquid mixing pump, and the air and the liquid for foaming are mixed to form foam and are then squeezed out from the foam nozzle. The foaming apparatus is convenient to use, triggers foam generation and extrusion by a sensor, and effectively avoids cross infection caused by hands making contact with the machine. Furthermore, the foam dispenser is compact, and advantageously uses a common pump for introduction of the air and liquid for production of foam therefrom.

The foregoing is merely preferred embodiments of the present disclosure and is not intended to limit the present disclosure in any way. While the present disclosure has been disclosed as above with reference to the preferred embodiments, they are not intended to limit the present disclosure. Any person skilled in the art can make use of the technical contents stated above to create equivalent embodiments with alterations or modifications which can be considered as equivalent variations, without departing from the scope of the technical solutions of the present disclosure. Any simple modifications, equivalent variations and modifications to the above embodiments in accordance with the technical essence of the present disclosure without departing from the contents of the technical solutions of the present disclosure are still within the scope.

What is claimed is:

1. A foam dispensing apparatus, comprising:
an air-liquid mixing pump comprising an electric motor coupled to a three-cavity part via an eccentric wheel and a movable connecting rod, a valve part, and an air-liquid mixing chamber for generation of foam,
a liquid storage bottle connected in communication with the air-liquid mixing pump through a pipe, said pipe having a check valve,
a foam nozzle connected in communication with the air-liquid mixing pump, and
a sensor arranged on one side of the foam nozzle connected electrically together with a control circuit board to a power supply device.

2. The foam dispensing apparatus according to claim 1, wherein a rotating shaft of the electric motor is connected with the eccentric wheel and wherein the movable connecting rod is fixedly connected with the eccentric wheel and the three-cavity part.

3. The foam dispensing apparatus according to claim 2, wherein the three-cavity part is provided with at least two air cavities and a liquid cavity, and the valve part is provided with air valves and a liquid valve for respectively cooperating with the air cavities and the liquid cavity; and a middle part of the valve part is provided with an intermediate valve for cooperating with the air-liquid mixing chamber.

4. The foam dispensing apparatus according to claim 1, wherein the three-cavity part is provided with a first clamp post, a second clamp post and a third clamp post for engaging with corresponding first clamp hole, second hole and third clamp hole in the movable connecting rod.

5. The foam dispensing apparatus according to claim 1, wherein the eccentric wheel is provided with a first shaft hole for connecting with the rotating shaft of the electric motor; and wherein a middle part of the movable connecting rod is provided with a fixed shaft, and the eccentric shaft is provided with a second shaft hole for connecting with the fixed shaft.

6. The foam dispensing apparatus according to claim 1, wherein the air-liquid mixing pump includes an accommodating part wherein the accommodating part is internally provided with an air inlet cavity and a liquid inlet cavity respectively corresponding to the air valve and the liquid valve.

7. The foam dispensing apparatus according to claim 6, wherein the accommodating part is provided with an air inlet hole corresponding to the air inlet cavity, and the accommodating part is provided with a liquid inlet channel corresponding to the liquid inlet cavity.

8. The foam dispensing apparatus according to claim 1, wherein a foam generator is installed between the foam nozzle and the air-liquid mixing pump, the foam generator comprising a foam outlet device and a foam inlet device, a foam outlet piece being provided between the foam inlet device and the foam outlet device, the foam outlet piece being provided with foam outlet holes uniformly arranged at intervals, the foam nozzle being provided with a sleeving post, and the sleeving post being sleeved inside the foam outlet device.

9. A foam generating dispenser, comprising
a sensing device electrically connected to a foam generator, the foam generator comprising an electric motor having a rotating shaft connected to an eccentric wheel,
a three-cavity part having at least two air cavities and a liquid cavity,
a movable connecting rod connected to the three-cavity part and fixedly connected to the eccentric wheel;
an air-liquid mixing chamber;
a valve part having air valves and a liquid valve for respectively cooperating with the air cavities and the liquid cavity of the three-cavity part; and a middle part provided to with an intermediate valve for cooperating with the air-liquid mixing chamber.

10. The foam generating dispenser according to claim 9, wherein the three-cavity part is provided with a first clamp post, a second clamp post and a third clamp post for cooperating with the movable connecting rod, and the movable connecting rod is provided with a first clamp hole, a second clamp hole and a third clamp hole for engaging with the first clamp post, the second clamp post and the third clamp post.

11. The foam generating dispenser according to claim 9, wherein the eccentric wheel is provided with a first shaft hole for connecting with the rotating shaft; and a middle part of the movable connecting rod is provided with a fixed shaft, the eccentric wheel is provided with a second shaft hole for connecting with the fixed shaft, and the second shaft hole is fixed to the movable connecting rod at a deviation angle.

12. The foam generating dispenser according to claim 9, wherein the sensing device comprises a sensing head and an electronic controller, the sensing head being electrically connected to the electronic controller, and the electronic controller being connected to the electric motor.

13. The foam generating dispenser according to claim 11, wherein the foam generator is internally provided with an accommodating part, and said accommodating part is internally provided with an air inlet cavity and a liquid inlet cavity respectively at locations corresponding to the air valve and the liquid valve.

14. The foam generating dispenser according to claim 13, wherein the accommodating part is provided with an air inlet hole corresponding to the air inlet cavity, and the accommodating part is provided with a liquid inlet channel corresponding to the liquid inlet cavity.

15. The foam generating dispenser according to claim 14, further including a foaming material bottle and a liquid inlet pipe, with one end of the liquid inlet pipe connected to the foaming material bottle, and the other end of the liquid inlet pipe being connected to the liquid inlet channel.

16. The foam generating dispenser according to claim 11, further comprising a delivery pipe and a foam outlet device, with one end of the delivery pipe being connected to the air-liquid mixing chamber, and the other end of the delivery pipe being connected to the foam outlet device.

17. The foam generating dispenser according to claim 16, wherein the foam outlet device is provided with a metal mesh sheet and a nozzle.

18. The foam generating dispenser according to claim 17, wherein the foam outlet device is internally provided with a number of through holes for uniform extrusion of foam therethrough.

19. A foam generating dispenser comprising
an electric motor connected to an eccentric wheel via a rotating shaft, the electric motor being actuable by a sensor;
a three-cavity part defining therein two cavities for receiving air therein and one cavity for receiving liquid therein,
a movable connecting rod fixedly connected to the eccentric wheel and to the three-cavity part for rotation thereof;
an air-liquid mixing chamber;
a valve part having two air valves operably coupled to the air cavities of the three-cavity part and a liquid valve coupled to the liquid cavity of the three-cavity part; and
a middle part provided with an intermediate valve for passage therethrough of the air and liquid to the air-liquid mixing chamber.

20. The foam generator according to claim 19 further comprising a nozzle attached to outlet of the air liquid mixing chamber, the nozzle comprising a plurality of holes therethrough.
